(19) United States
(12) Patent Application Publication
(10) Pub. No.: US 2011/0310112 A1
(43) Pub. Date: Dec. 22, 2011

(54) Method for statistical visualization of client service events

(75) Inventor: Alexandre Zolotovitski, Bellevue, WA (US)

(73) Assignee: Alexandre Zolotovitski, Bellevue, WA (US)

(21) Appl. No.: 13/065,656

(22) Filed: Mar. 28, 2011

Related U.S. Application Data
(60) Provisional application No. 61/341,542, filed on Mar. 31, 2010.

(51) Int. Cl. G06T 11/20; G09G 5/02

(52) U.S. Cl. 345/589; 345/440.2; 345/440

(57) ABSTRACT

For every business interaction with customers consists of cases and each case consists of sequence of events: First_Contact_Customer, . . . intermediate events, . . . Case_Closed. The most important characteristics are frequencies of transitions between events and mean time between events (MTBE, TBE) for each type of cases. Type of cases could be type of customer, group of products, branch of enterprise, geographical area, etc. Existed methods of visualization (the most popular of them are MS Excel pivot charts) could not visualize two characteristics (Frequency and MTBE) simultaneously to locate business problems.

Our method combines standard SPC run chart for time series representation with three new types of charts for cross-sectional representation: “matrix bar chart” for portraying types of cases, “flower bed chart” for displaying Frequencies and MTBE. and “Tower Chart” that can be element of “Flower Bed Chart” and “Matrix Bar Chart” when we need detailed visualization of distribution of TBE.

This new method is applicable for any customer service—help desks, stores, doctor offices, banks and gives the user ability to identify immediately the most business important factors

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO AN APPENDIX

Not Applicable

### BACKGROUND

### Field of Technology

The present invention relates generally to topical analysis of data presenting client service events in the field of Data processing: Visualization, Data Mining, Statistical process control (SPC), Performance monitoring, Operations research, Customer service.

### BRIEF SUMMARY

For every business interaction with customers consists of cases and each case consists of sequence of events: First_Contact_Customer, . . . intermediate events, . . . Case_Closed. The most important characteristics are frequencies of transitions between events and mean time between events (MTBE, TBE) for each type of cases. Type of cases could be type of customer, group of products, branch of enterprise, geographical area, etc. Existed methods of visualization (the most popular of them are MS Excel pivot charts) could not visualize two characteristics (Frequency and MTBE) simultaneously to locate business problems.

Our method combines standard SPC run chart for time series representation with three new types of charts for cross-sectional representation: “matrix bar chart” for portraying types of cases, “flower bed chart” for displaying Frequencies and MTBE, and “Tower Chart” that can be element of “Flower Bed Chart” and “Matrix Bar Chart” when we need detailed visualization of distribution of TBE.

This new method is applicable for any customer service—help desks, stores, doctor offices, banks and gives the user ability to identify immediately the most business important factors.

### BRIEF DESCRIPTION OF THE DRAWINGS

Table 1. Raw data, contains information about cases (it could be related to individual customers), DateTime stamps of Events, and Types used for classification of cased

Table 2. Raw data in the “long” format, contains the same information as Table 1, rearranged in “long” format.

Table 3. Sorted data of Table 2, ordered by Type—Case—DateTime with additional columns time between events and PrEv—previous event.

FIG. 1. OLAP Dimensions

Table 4. Aggregated data from individual cases to Types.

Table 5. Pivot table for Frequency

Table 6. Pivot table for Time

Table 7. Matrix Bar Chart for Freq and Time (2D)

Table 8. Matrix Bar Chart for Freq and Time (3D)

FIG. 3. Four variants of visual representation: arrows, bars, petals and towers.

FIG. 4. Screenshot of “Flower bed” chart

FIG. 5. Empirical CDF (left) and sorted sequence (right) of TBE={1, 1, 3, 3, 7 }.

FIG. 6. Tower Charts: Symmetrized sorted sequence of TBE with the same axes X as at FIG. 5 (a) and with compressed axes X: x=\sqrt{i}(b).

FIG. 7. 3D Towers—result of revolution of stepwise 2D tower and shaded area of FIG. 6b.

FIG. 8. Flower Bed Chart with “tower” petals

FIG. 9. Evolution of chart elements.

FIG. 10. Matrix Bar Chart for Type variables gHWP—group of HW Platform and gPrd—Group of Product.

FIG. 11. Correspondence between three type of charts and OLAP dimensions.

### DETAILED DESCRIPTION

### 1. Introduction

Improving performance of interaction with customers (“customer service”) is important business task of CRM for every business. In this work we have deal with the problem of visualization for Client service events to optimize work of client service. In order to do it we have to visualize business important characteristics related to customer service. The raw data related to customer service usually has form: see Table 1.

In our example of technical service center events were service cases, so variable Case was the foreign key identifying service case; the following columns are for. DateTime stamps for service events Ev1, Ev2, . . . that could be Creation—Received—Contact_SW—Contact_HW—Pending—Closed.

The Type columns could contain such variables as HW_Platform, Product, Geographic variables, Customer, Case_Owner and can be used for the Classification of cases. For simplicity we will show only one Type variable.

The same type of visualization can be done for analysis of events in other areas: reliability (failures), survival analysis (deceases), transport network flow analysis, network performability analysis, cross-sell and up-sell analysis in marketing, e.g. in the last case events could be purchases of specific products by a customer. For example, we could have deal with opening a sequence of bank accounts; then instead of Case we have CustomerID, and Event can be Open_Checking_Acct, Open_Saving_Acct, Open_Loan, Close_Checking Acct and so on; The Type could be BranchID or Group of Clients and can be used for the Classification of cases.

Tasks of this type are quite common in OLAP [1, 2].

### 2. Analysis of Data

More convenient is to present the data of Table 1 in the “long” format: see Table 2.

To analyze the table we sort it by Case, DateTime and create variables Previous Event (PrEv) and Time between Events (T): see Table 3.

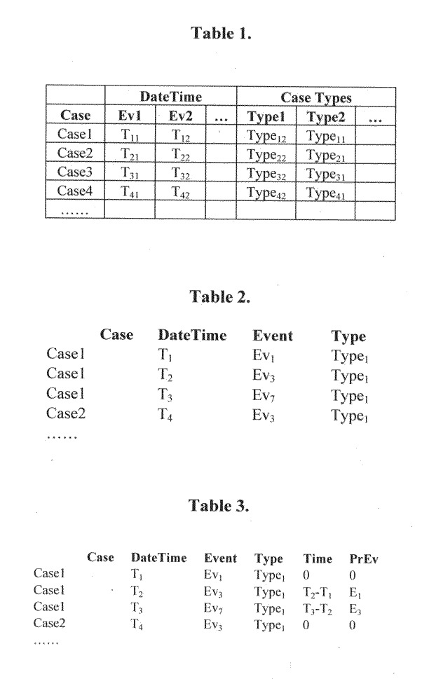

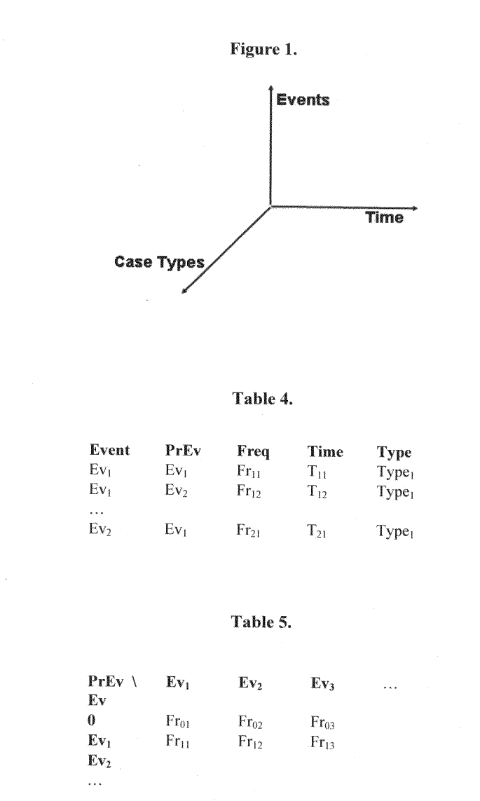

In terms of OLAP[1] we have multidimensional situation: see FIG. 1, where dimension “Case Type” can also be compound of dimensions “HW_Platform”, “Product”, Geographic variables, “Customer” and so on.

### 2.1. Longitudinal Analysis

For longitudinal analysis standard in statistical process. control (SPC) run chart is applicable and we will not discuss it.

### 2.2. Cross-Sectional Analysis For Sequence of Events

For cross-sectional analysis of quality of service we aggregate the data in Table 3 calculating count and average through Case and obtain two aggregating variables: Frequency (or Count) and Mean Time Between Events (MTBE, TBE) Time that is average of Time in Table 3: see Table 4.

During data aggregation from Table 1, instead of mean(T) we could use another aggregating function, e.g. mean(1/T) or Scale(T)=exp(mean(ln(T))). The latter makes sense because the distribution of time between events could be Weibull rather than normal. We will discuss this choice of aggregating function later.

Now transform the Table 4 to two “wide” (or pivot) tables: see Table 5 and Table 6.

The traditional way of visualizing these two tables—“Pivot Chart”—creates two stacked bar charts, and we should match elements of these two charts to identify business important cases, because both Frequency and Time are important.

The simplest way to improve the pivot charts to visualize these two tables is to put in the cells of the table bars with width proportional to Time and length proportional to Frequency, that we named a “Matrix Bar Chart”: see Table 7.

In this table the rows show frequency and average time of transactions following events PrEv and the columns show transactions that led to events Ev.

During data aggregation from Table 3 we could use the same type of chart but length of rectangle could be proportional mean(1/T) or Scale(T)=exp(mean(ln(T))). The latter makes sense because the distribution of time between events could be Weibull rather than normal.

We prefer to plot length of bars proportional mean (T) rather than scale(T) because sometimes lost for servicing company is proportional to time of service multiplied number of cases; in such situation areas of rectangles (bars) are proportional to dollar amount of loss related to these transactions, so just a short glance at the chart shows which process creates the majority of issues for the company.

Usually Frequencies are distributed in wide range of values, and more convenient to plot 3D bars with radius proportional to square root of frequency and plot the chart in 3D form: see Table 8.

In 3D representation volume of each bar is proportional to dollar amount of loss related to these transactions.

One disadvantage of this method is that each event is presented in the table twice: in raw header as Previous Event (PrEv) and in a column header as Event (Ev).

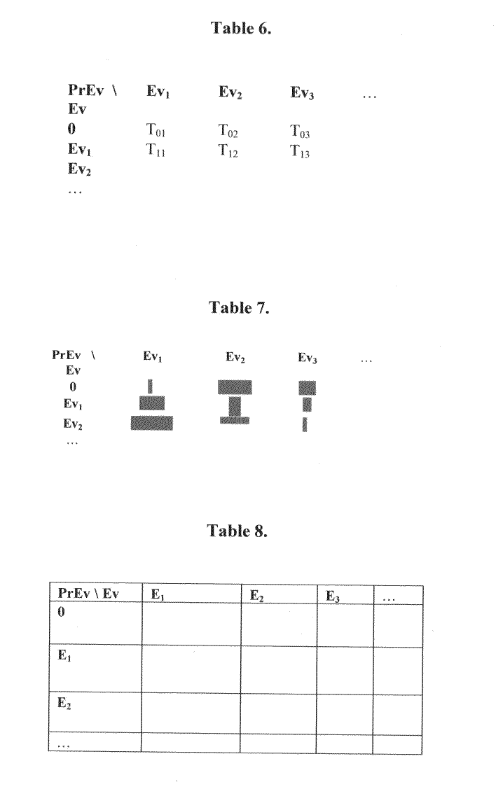

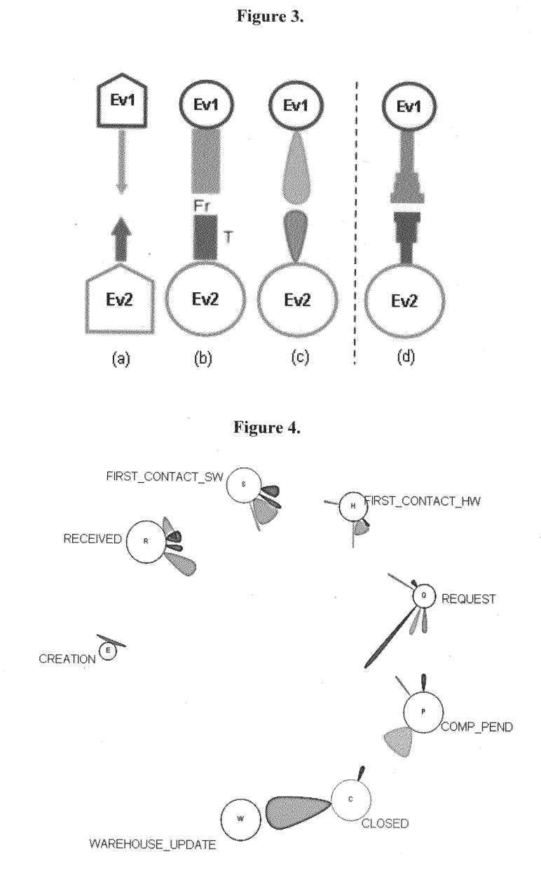

To visualize this table without doubling the events, we present events as circles or other figures (e.g. “houses”) with area proportional frequency of the events and represent frequency F12 and Time T12 as arrow (or bar or petal) from Ev1 to Ev2 with width proportional to F12 and length proportional T12, color of the arrow is the same as the color of circle Ev2: see FIG. 3.

We can choose positions of the circles arbitrarily; the simplest case is to put it on a big circle where all event circles “can see” each other. We use the order of event circles by increasing mean time from Event 0 (so the most petals are directed clockwise): see FIG. 4.

In the Flower Bed chart areas of petals again are proportional to dollar amount of loss related to these transactions, so just a short glance at the chart shows which process creates the majority of problems for the company: wide petals indicate business processes that happen frequently, long petals indicate business processes that take long time, and the most important business task is to optimize processes that are both long and wide.

In our special case we did not consider the possibility that an event can follow itself, which can be expected in many other real-world process-domains (for e.g., opening checking account followed by opening another checking account). The visualization technique itself has the power to show this (a purple circle can also have a purple petal that could be plotted out of center). We named the chart “flower bed” chart.

Another alternative could be to use standard techniques for weighted multidigraph visualization [3], but we think our “flower bed” chart is easier for interpretation and visual perception.

To increase amount of information presented by the chart, instead of bars or petals we can draw more complicated figures (“Tower Charts”) reflecting not only mean time between events but also distribution of the time. Usual histograms or violin plots can not be used to present distribution of time because size of the figures are not proportional to business importance ($$).

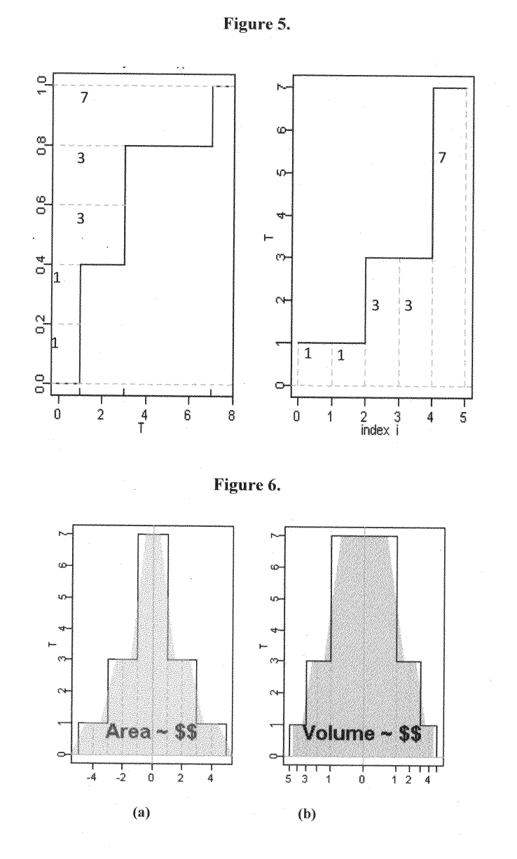

We show creation of Tower Chart on simple example when for specific combination of (Ev, PrEv) we observe the sequence of N=5 TBE: 1, 3, 7, 1, 3 time units. See FIG. 5.

Plot of sorted TBE (right chart) is stretched empirical quantile function Q(p) that is inversed empirical CDF (ECDF):

f(i)=Q(i/N)=ECDF−1(i/N)

It is obviously from comparison of area under f(i) and area left of ECDF. If 1 case*1 day costs $1, then area under f(i) is exactly equal to business importance (dollar amount). More convenient to use symmetrical chart joining increasing and decreasing sequences of TBE: see FIG. 6.

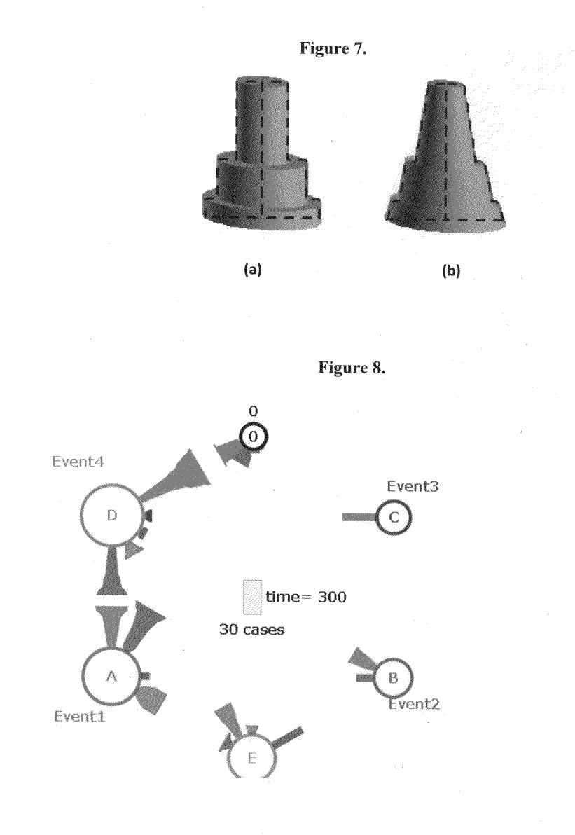

We can use (a) stepwise (solid line) function, or (b) smoothed border of shaded area that is related to empirical quantile function as we mentioned above. If we rotate these lines around vertical axis Oy, then we get solid of revolution (“3D Tower”): see FIG. 7.

Volume of the solid of the 3D Tower again is exactly equal to business importance (dollar amount), area of base is proportional to total number of cases and height—to max(TBE). The left (a) tower consists of three cylinder rings: the internal one has height=7 and area=1; the middle ring has height=3 and area=2; the external ring has height=1 and area=2. For simplicity we will not plot on Flower Bed Chart 3D figure, but only its section (contour) that is drawn by dashed line in FIG. 7 or solid line in FIG. 6: see FIG. 8.

In the Flower Bed Chart at FIG. 8 we put in the center grey “scale bar” and used petals directed from each event circles to Event-0 and colored at the same color as the event circle to represent cases when the event was following by another event of the same type. This version of Flower Bed Chart allows easy identify outliers and other anomalies in distribution of TBE.

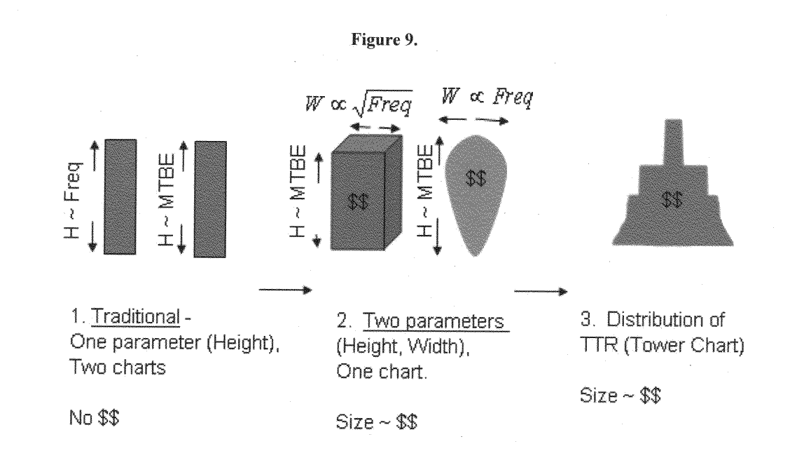

The FIG. 9 shows evolution of chart elements to represent more information: see FIG. 9.

Some additional information can be reflected by position of event circles as in widely used bubble charts.

We have to create the “flower bed” chart (FIG. 4, 8) for each Type of cases to compare quality of service between different Types.

### 2.3. Cross-Sectional Analysis For Types of Cases

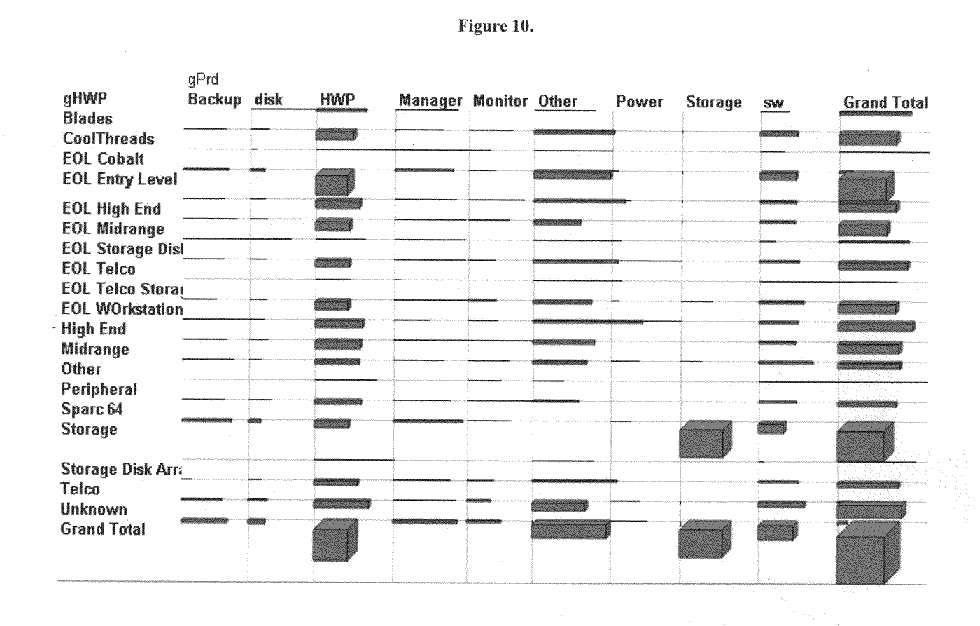

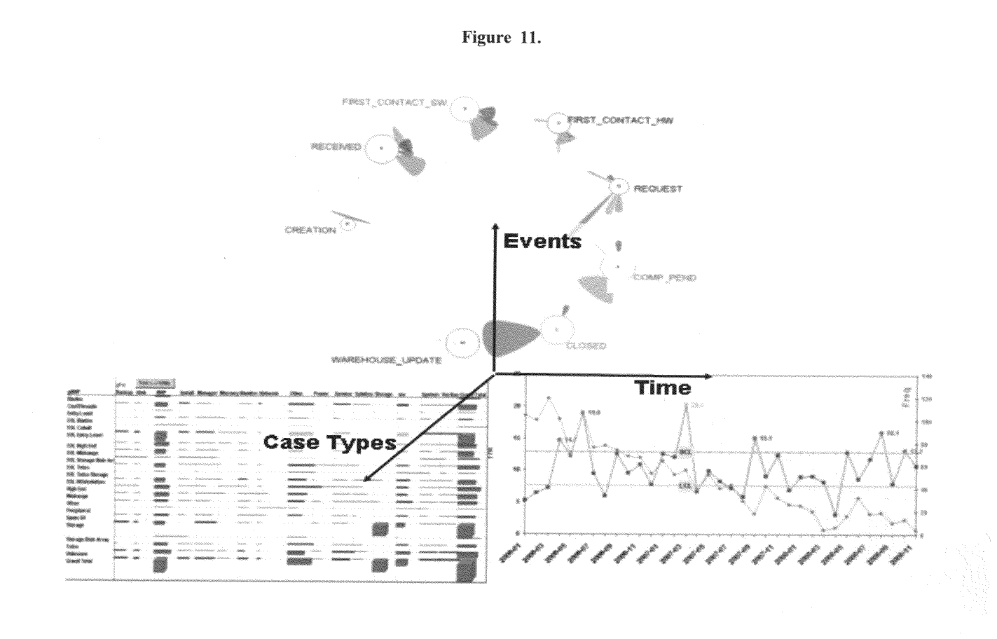

For comparison of TTR and frequencies between Types we use the same graphic representation as in Table 4d, but instead of events rows and columns of the table can correspond to combination of two Type variables: see FIG. 10.

Again, if we suppose one case in one day costs $1, then total cost of service is proportional to volume of the bars (cuboid) in Grand Total—Grand Total cell that ids in right-down corner of the table, that equal sum of volumes (or $ amounts) of cuboids in Grand Total Row or Grand Total column that represent cost allocated to specific HWP or Product, and each of Grand total volume equal sum of cuboids volumes (or $ amounts) located in proper row or column.

More accurately, instead of “one case in one day costs $1” we could use cost matrix taking in account dependence of cost on specific HWP and Product, and plot volume of each cuboid proportional to the cost. The same approach could be applied to Flower Bed Chart.

As in case of Flower Bed Chart, if we need to reflect more information about distribution of TTR than mean and frequency, we can use tower charts instead of bars.

1. Presentation of sequence of events and transitions between events characterized by time between events (TBE) in two tables: 1) for frequencies of events and transitions between events and 2) mean TBE or another aggregating function of TBE.

2. Representing these tables as “matrix bar chart” elements of which has two parameters corresponding to frequencies of transitions between events and mean TBE or another aggregating function of TBE.

3. Representing the tables (2) as “flower bed chart” with two types of elements: elements of first type (“event homes”) has one parameter characterizing frequencies of events and displayed with different colors; elements of second type (“petals” or arrows) are directed between “event homes” and have two parameters corresponding to frequencies of transitions between events (“from” and “to”) and mean TBE or another aggregating function of TBE. The color of the “petals” is the same as color of “event home” of event “to”.

4. Representing a set of TBE as “tower chart” (5) that is result of rotation of transformed inverse empirical cumulative distribution function (quantile function) and can be uses as petals of “flower bed chart” (4)
